(19) United States
(12) Patent Application Publication
(10) Pub. No.: US 2026/0228258 A1
(43) Pub. Date: Aug. 6, 2026

(54) INFORMATION PROCESSING APPARATUS FOR SUPPORTING DECISION MAKING USING ARTIFICIAL INTELLIGENCE

(71) Applicant: NEC Corporation, Tokyo (JP)

(72) Inventors: Michimasa IRIE, Tokyo (JP); Katsuaki TAYA, Tokyo (JP); Taichiro SANO, Tokyo (JP)

(73) Assignee: NEC Corporation, Tokyo (JP)

(21) Appl. No.: 19/454,549

(22) Filed: Jan. 21, 2026

(30) Foreign Application Priority Data
Feb. 6, 2025 (JP) 2025-018702

(51) Int. Cl. G06F 16/3329; G06F 40/40

(52) U.S. Cl. CPC G06F 16/33295; G06F 40/40

(57) ABSTRACT

An information processing apparatus of the present disclosure includes an acquisition unit that acquires observation information based on observation of a mobile body and acquires related information related to the mobile body from information generated in advance, a generation unit that generates a question sentence based on the observation information and the related information, and a response unit that inputs the question sentence to a model and obtains an answer to the question sentence from the model.

### INCORPORATION OF BASIC APPLICATION

The present invention is based upon and claims the benefit of the priority of Japanese Patent Application No. 2025-018702 filed on Feb. 6, 2025 in Japan, the disclosure of which is incorporated herein in its entirety by reference.

### TECHNICAL FIELD

The present disclosure relates to an information processing apparatus.

### BACKGROUND ART

The number of artificial satellites on the earth's orbit is increasing year by year, and there is an increasing need to monitor the satellites and track their movement. For example, PTL 1 describes that monitoring data of a space object such as an artificial satellite is acquired.
PTL 1: Japanese Unexamined Patent Application Publication No. 2022-166933

### SUMMARY

However, as described in PTL 1, there arises a problem that it is difficult to estimate the intention of the movement of a space object only with monitoring data acquired from the space object. The same problem occurs not only for a space object but also for any mobile body.

Therefore, an object of the present disclosure is to solve the above-described problem that it is difficult to estimate the intention of the movement of a mobile body.

An information processing apparatus according to an aspect of the present disclosure includes
an acquisition unit that acquires observation information based on observation of a mobile body and acquires related information related to the mobile body from information generated in advance,
a generation unit that generates a question sentence based on the observation information and the related information, and
a response unit that inputs the question sentence to a model and obtains an answer to the question sentence from the model.

An information processing method according to an aspect of the present disclosure includes
an information processing apparatus
acquiring observation information based on observation of a mobile body and acquiring related information related to the mobile body from information generated in advance,
generating a question sentence based on the observation information and the related information, and
inputting the question sentence to a model to obtain an answer to the question sentence from the model.

A program according to an aspect of the present disclosure causes
an information processing apparatus to execute processing of
acquiring observation information based on observation of a mobile body and acquiring related information related to the mobile body from information generated in advance,
generating a question sentence based on the observation information and the related information, and
inputting the question sentence to a model to obtain an answer to the question sentence from the model.

With the above configuration, the present disclosure enables easy estimation of the intention of the movement of a mobile body.

### BRIEF DESCRIPTION OF THE DRAWINGS

FIG. 1 is a block diagram illustrating an example of a configuration of an information processing apparatus according to the present disclosure;

FIG. 2 is a flowchart illustrating an example of a processing operation of the information processing apparatus according to the present disclosure;

FIG. 3 is a diagram illustrating an example of processing related to the information processing apparatus according to the present disclosure;

FIG. 4 is a diagram illustrating an example of processing by the information processing apparatus according to the present disclosure;

FIG. 5 is a diagram illustrating an example of processing by the information processing apparatus according to the present disclosure;

FIG. 6 is a block diagram illustrating an example of a configuration of an information processing apparatus according to the present disclosure;

FIG. 7 is a flowchart illustrating an example of a processing operation of the information processing apparatus according to the present disclosure;

FIG. 8 is a diagram illustrating an example of processing by the information processing apparatus according to the present disclosure;

FIG. 9 is a block diagram illustrating an example of a hardware configuration of the information processing apparatus according to the present disclosure;

FIG. 10 is a block diagram illustrating an example of a configuration of the information processing apparatus according to the present disclosure; and

FIG. 11 is a flowchart illustrating an example of a processing operation of the information processing apparatus according to the present disclosure.

### EXAMPLE EMBODIMENT

### First Example Embodiment

A first example embodiment of the present disclosure will be described with reference to the drawings. The drawings may relate to any example embodiment.

As an example, an information processing apparatus of the present disclosure is used to estimate the movement of an artificial satellite (hereinafter referred to as satellite) on the earth's orbit by observing the satellite. However, in the present disclosure, an object to be observed to estimate the movement is not limited to a satellite, and may be any mobile body moving in any region, such as a space object flying in space, a flying object such as an airplane or a rocket, or a ship or a submarine.

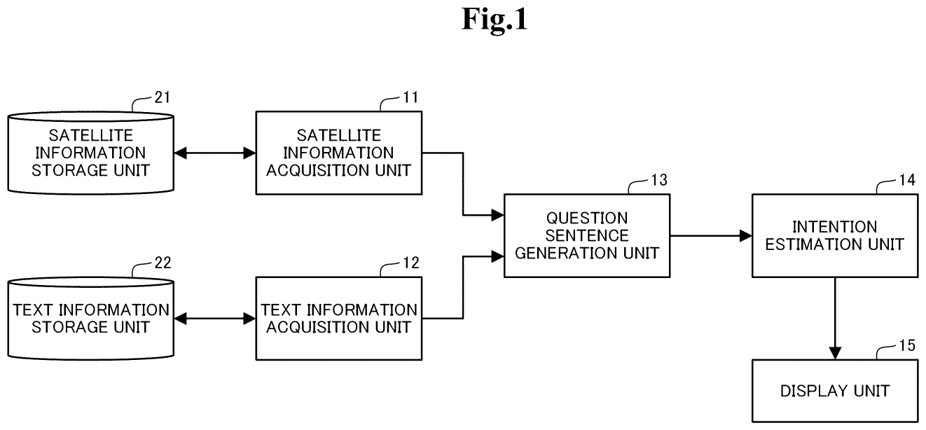

Hereinafter, an example of a configuration and an operation of the information processing apparatus according to the present example embodiment will be described. The information processing apparatus is constituted by a single or a plurality of information processing apparatuses including an arithmetic device and a storage device. Then, as illustrated in FIG. 1, the information processing apparatus includes a satellite information acquisition unit 11, a text information acquisition unit 12, a question sentence generation unit 13, an intention estimation unit 14, and a display unit 15. Each function of the satellite information acquisition unit 11, the text information acquisition unit 12, the question sentence generation unit 13, the intention estimation unit 14, and the display unit 15 can be implemented by the arithmetic device executing a program for achieving each function stored in the storage device. The information processing apparatus also includes a satellite information storage unit 21 and a text information storage unit 22 implemented by a storage device. However, the satellite information storage unit 21 and the text information storage unit 22 may be provided outside the information processing apparatus and connected to the information processing apparatus.

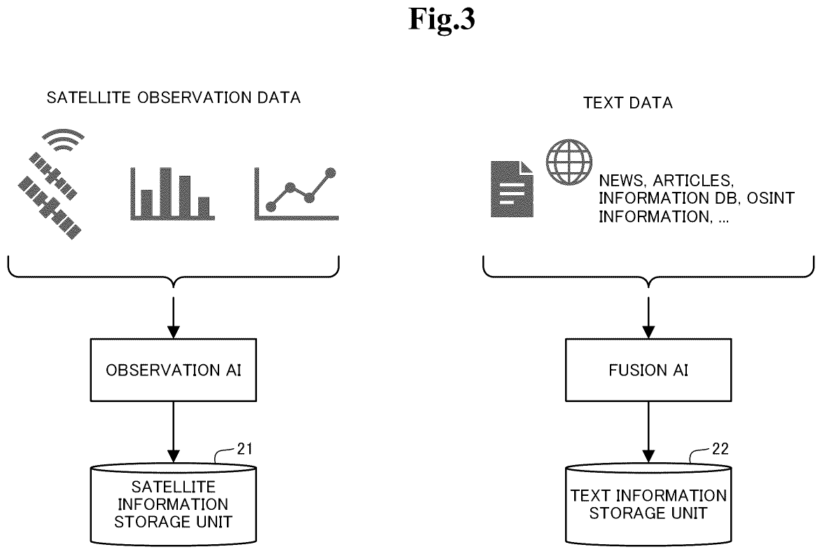

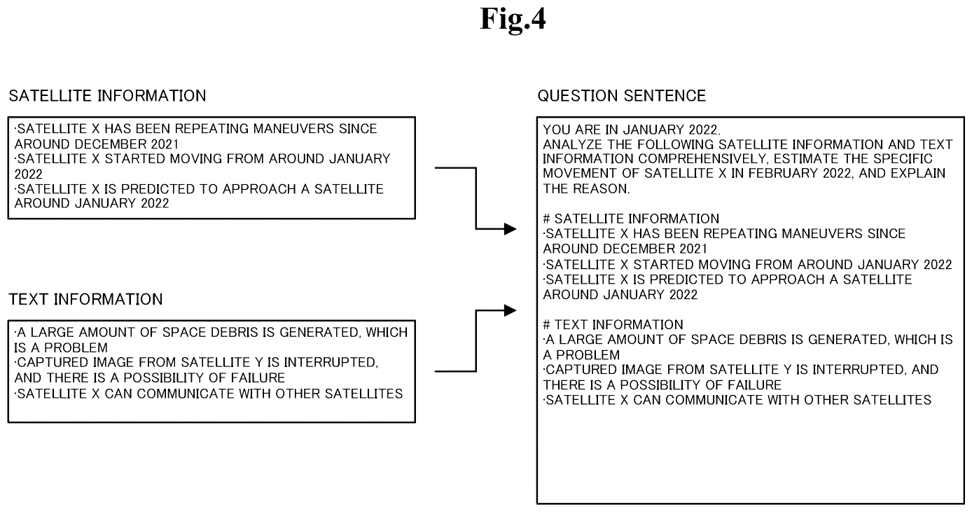

The satellite information storage unit 21 stores satellite information (observation information) that is information based on observation data obtained by observing the satellite. For example, the observation data is data by numerical values, tables, or graphs indicating an orbit of a satellite, a detection value of equipment mounted on the satellite, such as a power amount, a measurement value measured by the satellite, and the like. Then, as illustrated in FIG. 3, the observation data is processed into satellite information in various data formats, for example, a necessary data portion is extracted by observation artificial intelligence (AI) generated in advance by machine learning, or observation data such as a numerical value is analyzed and converted into text, and is stored in the satellite information storage unit 21. As an example, as illustrated in FIG. 4 described later, the satellite information is stored as information in text indicating the contents of the operation and situation of a satellite X. At this time, the satellite information may include date and time information when the observation data was observed. However, the satellite information is not limited to information in text, and observation data itself such as numerical values may be stored. The observation AI may be constituted by a large language model (LLM) as an example.

The text information storage unit 22 stores text information based on information generated in advance, specifically text information (related information) of contents related to satellites. For example, generated information is information stored in a web server or database on the Internet, and is, for example, information in text such as a news article, a satellite information database, government announcement information, a social networking service (SNS) post, and OSINT information. Then, as illustrated in FIG. 3, generated information in text is stored in the text information storage unit 22 as text information by, for example, extracting or summarizing a data portion of contents related to satellites by fused AI generated in advance by machine learning. In the present example embodiment, text information is assumed to be information including contents related to satellites, such as text of contents related to space or contents related to a specific satellite as illustrated in FIG. 4 described later. The observation AI may be constituted by a large language model as an example.

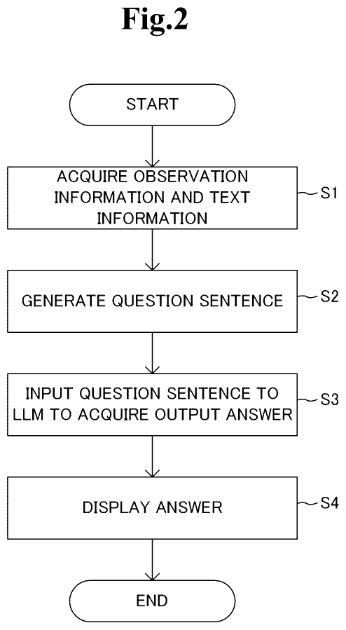

The satellite information acquisition unit 11 (acquisition unit) acquires satellite information relevant to a target satellite from the satellite information storage unit 21 described above (step S1 in FIG. 2). For example, in a case where a target satellite is “satellite X”, satellite information based on observation data of the satellite X is acquired. As an example, the satellite information acquisition unit 11 acquires satellite information as illustrated in FIG. 4. In the example of FIG. 4, the satellite information has contents representing the operation of the satellite X analyzed from numerical values of observation data, and includes date and time information. However, the satellite information may be contents representing any situation of the satellite X, or may be the actual observation data by numerical values. The satellite information need not include date and time information.

The text information acquisition unit 12 (acquisition unit) acquires text information relevant to the target satellite from the text information storage unit 22 described above (step S1 in FIG. 2). For example, in a case where the target satellite is “satellite X”, the text information acquisition unit 12 acquires text information including information on the space itself in which the satellite is present, information indicating the operation and situation of the satellite X itself, and information indicating the operation and situation of another satellite. As an example, the text information acquisition unit 12 acquires text information as illustrated in FIG. 4. In the example of FIG. 4, the text information has contents related to space and contents related to the satellite X and the satellite Y, but the text information may have any content.

The question sentence generation unit 13 (generation unit) generates a question sentence (prompt) to be input to the language model based on the acquired satellite information and text information (step S2 in FIG. 2). Specifically, as illustrated in FIG. 4, the question sentence generation unit 13 generates a question sentence including the acquired satellite information and text information, the question sentence including an instruction sentence requesting the language model to provide an answer that is content for estimating the movement of the target satellite X. At this time, the instruction sentence includes contents desired to be executed by the language model, and as an example, includes instruction contents for analyzing the movement of the target satellite X or estimating the intention of the movement. The question sentence may include a content instructing to output the reason for the estimation together with the content to be estimated, and may further include a content instructing to output a plurality of estimated contents. The instruction sentence may include words instructing to perform estimation based on both the satellite information and the text information.

In a case where date and time information is included in the satellite information, the question sentence generation unit 13 generates a question sentence corresponding to the date and time information. As an example, as illustrated in FIG. 4, the question sentence generation unit 13 designates date and time information included in the satellite information as the current date and time, and generates a question sentence including an instruction sentence instructing an answer to estimate the movement of the satellite X on the subsequent date and time. The question sentence generation unit 13 generates a question sentence including all of the acquired satellite information and text information, but is not necessarily limited to including all of the information, and may generate a question sentence including a part of the acquired satellite information and text information.

The intention estimation unit 14 (response unit) inputs the generated question sentence to the language model and acquires an answer to the question sentence that is an output from the language model (step S3 in FIG. 2). In the present example embodiment, the intention estimation unit 14 itself constitutes a language model, and includes, for example, a large language model (LLM). However, the language model may be provided outside the information processing apparatus, and the intention estimation unit 14 may input a question sentence to the external language model and acquire an answer to the question sentence output from the external language model.

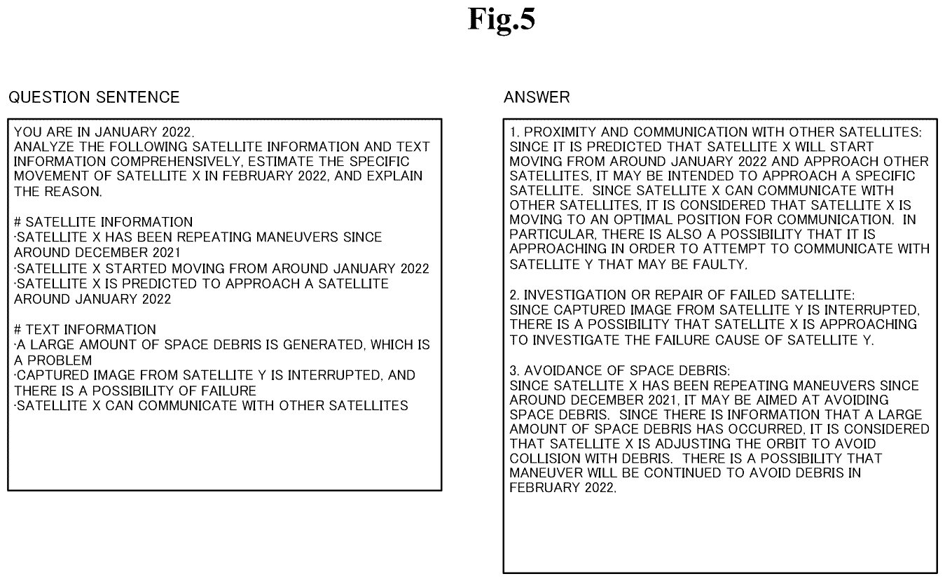

For example, the intention estimation unit 14 acquires an answer as illustrated in FIG. 5 from the language model. At this time, the answer includes contents for estimating the intention of the movement of the satellite X, and may include a plurality of estimated contents or may include a reason for the estimation. The estimated content at the date and time designated by the question sentence may be included.

The display unit 15 displays and outputs the estimated content of the movement of the satellite X which is the answer acquired from the language model as described above (step S4 in FIG. 2). At this time, as illustrated in FIG. 5, the display unit 15 also displays the question sentence input to the language model in order to obtain an answer. However, the display unit 15 may display a part of the question sentence, for example, only the instruction sentence or only a part of the satellite information or the text.

As described above, in the present disclosure, it is possible to obtain an answer for estimating the movement of a satellite by inputting, to a language model, a question sentence including text information related to the satellite in addition to satellite information obtained by observing the satellite. Therefore, it is possible to obtain the estimation result of the movement of the satellite based on various information related to the satellite from the language model, and to easily recognize the intention of the movement of the satellite.

### Second Example Embodiment

Next, a second example embodiment of the present disclosure will be described with reference to the drawings. The drawings may relate to any example embodiment.

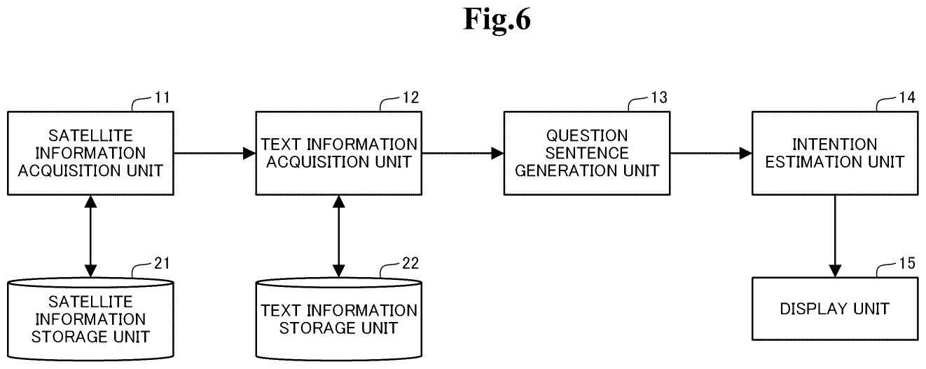

As illustrated in FIG. 6, an information processing apparatus according to the present example embodiment has a configuration similar to that of the first example embodiment described above. A satellite information acquisition unit 11 and a text information acquisition unit 12 of the information processing apparatus in the present example embodiment are constituted as follows. Hereinafter, a configuration different from the above will be mainly described.

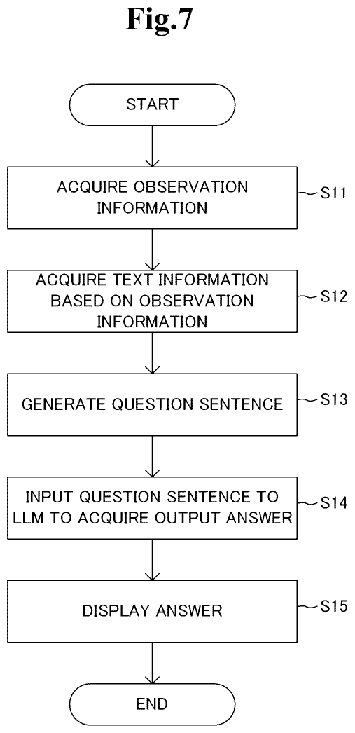

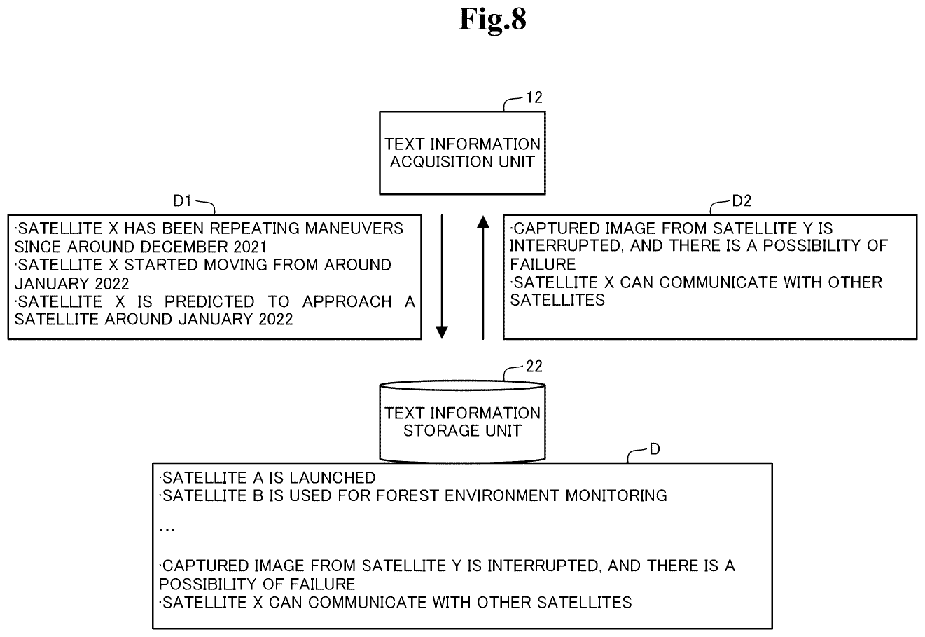

The satellite information acquisition unit 11 in the present example embodiment outputs acquired satellite information to the text information acquisition unit 12 (step S11 in FIG. 7). Then, the text information acquisition unit 12 in the present example embodiment acquires text information from a text information storage unit 22 based on the content of the input satellite information (step S12 in FIG. 7). For example, the text information acquisition unit 12 searches the text information storage unit 22 for text information related to the contents of the satellite information by using a technology called retrieval-augmented generation (RAG), and acquires text information related to the satellite information. As an example, as illustrated in FIG. 8, in a case where information D related to a satellite A, a satellite B, a satellite Y, and a satellite X is stored in the text information storage unit 22, information D2 related to the satellite X and the satellite Y is searched for and acquired as information related to the satellite X included in satellite information D1. As an example, in a case where the satellite information includes date and time, the satellite information acquisition unit 11 may search for and acquire text information relevant to a period (e.g., previous and latter six months) identified by the date and time.

Thereafter, a question sentence generation unit 13 of the information processing apparatus generates a question sentence based on the observation information and the text information acquired in the same manner as described above (step S13 in FIG. 7), and an intention estimation unit 14 inputs the question sentence into a language model to acquire an answer (step S14 in FIG. 7). Then, a display unit 15 of the information processing apparatus displays the acquired answer (step S15 in FIG. 7).

As described above, in the present disclosure, text information is acquired based on the acquired satellite information, and a question sentence is generated based on the acquired text information. Therefore, it is possible to generate a question sentence that can be more relevant to the satellite information, and it is possible to obtain more appropriate contents as the estimation of the movement of the target satellite. As a result, it is possible to more easily recognize the intention of the movement of the satellite.

### Third Example Embodiment

Next, a third example embodiment of the present disclosure will be described. An information processing apparatus according to the present example embodiment has a configuration similar to that of the first or second embodiment described above. The information processing apparatus according to the present example embodiment is further constituted as follows. Hereinafter, a configuration different from the above will be mainly described.

A satellite information storage unit 21 according to the present example embodiment stores satellite information including images and sounds. For example, image information captured by a camera installed in a satellite and sound information acquired by a microphone installed in the satellite are stored as satellite information. The satellite information storage unit 21 also stores satellite information including the above-described numerical values and sentences. Accordingly, a satellite information acquisition unit 11 according to the present example embodiment acquires, from the satellite information storage unit 21, satellite information including image information and sound information in addition to satellite information including numerical values and sentences.

A text information storage unit 22 in the present example embodiment stores generated information including images and sound generated in advance. For example, information stored in a web server or a database on the Internet, image information obtained by capturing an image of space, sound information recorded in space, and information obtained by editing the image information and the sound information are stored as generated information. The text information storage unit 22 also stores the above-described text information. Accordingly, a text information acquisition unit 12 according to the present example embodiment acquires, from the text information storage unit 22, generated information (related information) including image information and sound information in addition to text information.

A question sentence generation unit 13 according to the present example embodiment generates a question sentence (prompt) to be input to a language model based on satellite information including image information and sound information, text information, and generated information including image information and sound information. Specifically, the question sentence generation unit 13 generates a question sentence including satellite information and generated information including image information and sound information as the question sentence as illustrated in FIG. 4.

An intention estimation unit 14 according to the present example embodiment inputs the generated question sentence to the language model, and acquires an answer to the question sentence that is an output from the language model. At this time, the language model in the present example embodiment is a multimodal model machine-learned to receive an input of a question sentence including data in a plurality of data formats and output an answer in a plurality of data formats. For example, the multimodal model is configured to receive an input of a multimodal question sentence including data in a data format such as text data, audio data, or image data, and output a multimodal answer including data in a data format such as text data, audio data, or image data. As a result, the intention estimation unit 14 inputs a multimodal question sentence including data such as text data, audio data, and image data to the multimodal model, thereby obtaining a multimodal answer including data such as text data, audio data, and image data output from the multimodal model.

A display unit 15 in the present example embodiment displays and outputs the multimodal estimated content of the movement of the satellite X which is the answer acquired from the language model as described above. That is, in a case where the answer includes image information and sound information, the display unit 15 also outputs the image information and the sound information.

As described above, in the present disclosure, it is possible to obtain an answer for estimating the movement of a satellite including information of image and sound by inputting, to a model, a question sentence including not only text information but also information of image and sound. Therefore, it is possible to obtain the estimation result of the movement of the satellite based on various information related to the satellite from the model, and to easily recognize the intention of the movement of the satellite.

### Fourth Example Embodiment

Next, a fourth example embodiment of the present disclosure will be described with reference to the drawings. In the present example embodiment, an outline of the information processing apparatus and the like described in the above example embodiment will be illustrated. The drawings may relate to any example embodiment.

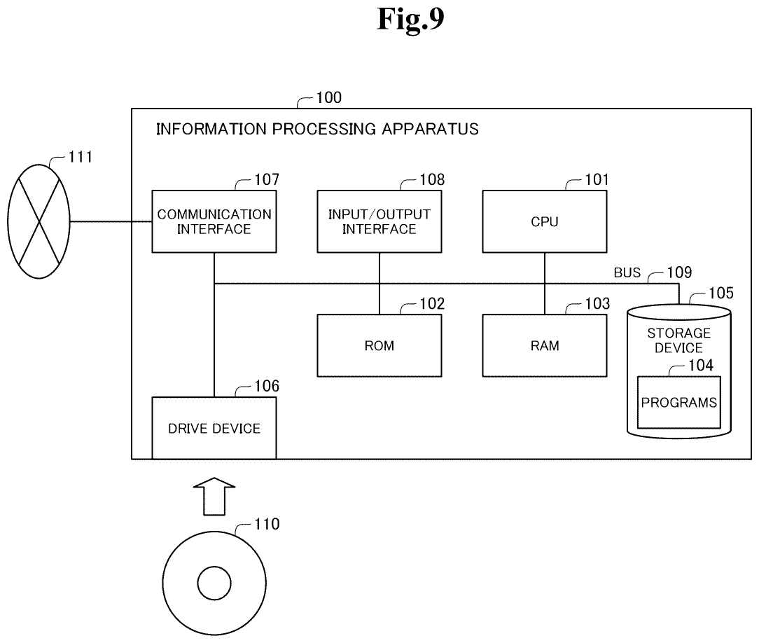

First, a hardware configuration of an information processing apparatus 100 according to the present disclosure will be described. The information processing apparatus 100 is constituted by a general information processing apparatus and, in one example, is equipped with the hardware configuration as follows, as illustrated in FIG. 9.
Central processing unit (CPU) 101 (arithmetic device)
Read only memory (ROM) 102 (storage device)
Random access memory (RAM) 103 (storage device)
Programs 104 to be loaded into RAM 103
Storage device 105 storing programs 104
Drive device 106 for performing reading and writing on storage medium 110 outside information processing apparatus
Communication interface 107 connected to communication network 111 outside information processing apparatus
Input/output interface 108 for inputting and outputting data
Bus 109 for connecting each component

FIG. 9 illustrates an example of the hardware configuration of the information processing apparatus that is the information processing apparatus 100, and the hardware configuration of the information processing apparatus is not limited to the above case. For example, the information processing apparatus may be constituted by a part of the above configuration such as not including the drive device 106. Instead of the CPU described above, the information processing apparatus can use a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

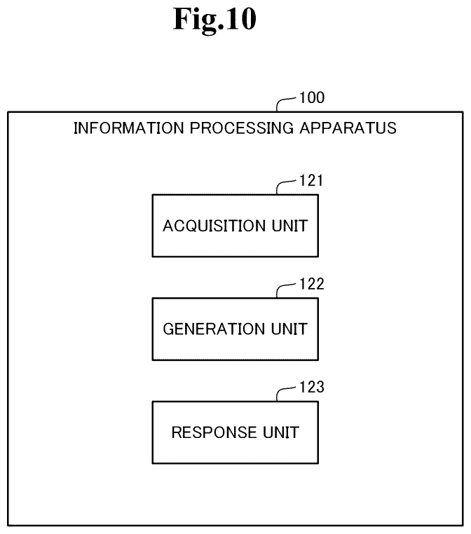

Then, the CPU 101 acquires and executes the programs 104 in such a way that the information processing apparatus 100 can construct and equip an acquisition unit 121, a generation unit 122, and a response unit 123 illustrated in FIG. 10. The programs 104 are stored, for example, in the storage device 105 or the ROM 102 in advance, and the CPU 101 loads and executes the stored programs 104 on the RAM 103, as necessary. The programs 104 may be supplied to the CPU 101 via the communication network 111, or the drive device 106 may read the programs stored in the storage medium 110 in advance and supply the read programs to the CPU 101. However, the acquisition unit 121, the generation unit 122, and the response unit 123 described above may be constructed by a dedicated electronic circuit for implementing the means.

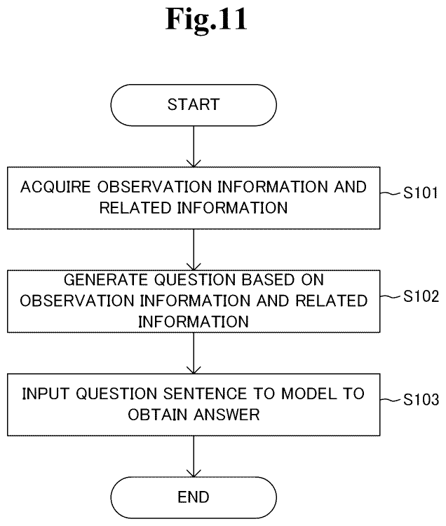

The acquisition unit 121 acquires observation information based on observation of a mobile body, and acquires related information related to the mobile body from information generated in advance (step S101 in FIG. 11). The generation unit 122 generates a question sentence based on the observation information and the related information (step S102 in FIG. 11). The response unit 123 inputs a question sentence to a model and obtains an answer to the question sentence from the model (step S103 in FIG. 11).

In the above configuration, the information processing apparatus 100 inputs, to the model, a question sentence including related information related to the mobile body in addition to the observation information obtained by observing the mobile body, and obtains an answer for estimating the movement of the mobile body. For example, a question sentence including information indicating the situation of a space where the mobile body exists and information of the mobile body itself or another related mobile body is generated and input into a model to obtain an answer. Therefore, it is possible to obtain the estimation result of the movement of the mobile body based on various information related to the mobile body from the model, and to easily recognize the intention of the movement of the mobile body.

At least one or more of the functions of the acquisition unit 121, the generation unit 122, and the response unit 123 described above may be executed by an information processing apparatus installed and connected at any place on a network, that is, so-called cloud computing.

The programs described above can be stored using various types of non-transitory computer readable media and supplied to a computer. The non-transitory computer readable media include various types of tangible recording media (tangible storage media). Examples of the non-transitory computer readable medium include a magnetic recording medium (e.g., flexible disk, magnetic tape, or hard disk drive), an optical magnetic recording medium (e.g., magneto-optical disc), a CD read only memory (ROM), a CD-R, a CD-R/W, and a semiconductor memory (e.g., mask ROM, programmable ROM (PROM), erasable PROM (EPROM), a flash ROM, or a random access memory (RAM)). The programs may also be supplied to the computer by various types of transitory computer readable media. Examples of the transitory computer readable media include electrical signals, optical signals, and electromagnetic waves. The transitory computer readable media can supply the programs to the computer via a wired communication path such as an electric wire and an optical fiber or a wireless communication path.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment described above can be appropriately combined with other example embodiments.

### Supplementary Note

Some or all of the above example embodiments may be described as in the following supplementary notes. Hereinafter, an outline of configurations of the information processing apparatus, the information processing method, and the program according to the present disclosure will be described. However, the present disclosure is not limited to the configurations described in the following supplementary notes. Some or all of the configurations described in Supplementary Notes 2 to 8 dependent on Supplementary Note 1 described below and the functions according to those configurations can also be dependent on other Supplementary Notes 9 and 10 by a dependency relationship similar to that of Supplementary Notes 2 to 8. Moreover, some or all of the configurations described as the supplementary notes and the functions according to those configurations can be similarly dependent on not only Supplementary Notes 1, 9, and 10, but also various pieces of similar hardware and software, and various types of recording means that record the software, or systems without departing from the above-described example embodiments.

### Supplementary Note 1

An information processing apparatus including:
an acquisition unit that acquires observation information based on observation of a mobile body and acquires related information related to the mobile body from information generated in advance;
a generation unit that generates a question sentence based on the observation information and the related information; and
a response unit that inputs the question sentence to a model and obtains an answer to the question sentence from the model.

### Supplementary Note 2

The information processing apparatus according to Supplementary Note 1,further including
a display unit that generates and displays the question sentence including at least a part of the observation information and the related information, and displays the answer.

### Supplementary Note 3

The information processing apparatus according to Supplementary Note 1, in which
the acquisition unit acquires the related information based on a content of the observation information.

### Supplementary Note 4

The information processing apparatus according to Supplementary Note 3, in which
the acquisition unit acquires the related information according to a date and time relevant to the observation information.

### Supplementary Note 5

The information processing apparatus according to Supplementary Note 1, in which
the generation unit generates the question sentence according to a date and time relevant to the observation information.

### Supplementary Note 6

The information processing apparatus according to Supplementary Note 1, in which
the generation unit generates the question sentence requesting the answer for estimating a movement of the mobile body.

### Supplementary Note 7

The information processing apparatus according to Supplementary Note 1, in which
the acquisition unit acquires text information including a sentence of a content related to the mobile body as the related information.

### Supplementary Note 8

The information processing apparatus according to Supplementary Note 1, in which
the acquisition unit acquires satellite information obtained by observing a satellite that is the mobile body as the observation information.

### Supplementary Note 9

An information processing method including
an information processing apparatus
acquiring observation information based on observation of a mobile body and acquiring related information related to the mobile body from information generated in advance,
generating a question sentence based on the observation information and the related information, and
inputting the question sentence to a model to obtain an answer to the question sentence from the model.

### Supplementary Note 10

A program for causing an information processing apparatus to execute processing of:
acquiring observation information based on observation of a mobile body and acquiring related information related to the mobile body from information generated in advance;
generating a question sentence based on the observation information and the related information; and
inputting the question sentence to a model to obtain an answer to the question sentence from the model.

### REFERENCE SIGNS LIST

11 satellite information acquisition unit
12 text information acquisition unit
13 question sentence generation unit
14 intention estimation unit
15 display unit
21 satellite information storage unit
22 text information storage unit
100 information processing apparatus
101 CPU
102 ROM
103 RAM
104 programs
105 storage device
106 drive device
107 communication interface
108 input/output interface
109 bus
110 storage medium
111 communication network
121 acquisition unit
122 generation unit
123 response unit

1. An information processing apparatus comprising:
at least one memory configured to store processing instructions; and
at least one processor configured to execute the processing instructions to:
acquire observation information based on observation of a mobile body and acquire related information related to the mobile body from information generated in advance;
generate a question sentence based on the observation information and the related information; and
input the question sentence to a model and obtain an answer to the question sentence from the model.

2. The information processing apparatus according to claim 1, wherein the at least one processor is configured to execute the processing instructions to
generate and display the question sentence including at least a part of the observation information and the related information, and display the answer.

3. The information processing apparatus according to claim 1, wherein the at least one processor is configured to execute the processing instructions to
acquire the related information based on a content of the observation information.

4. The information processing apparatus according to claim 3, wherein the at least one processor is configured to execute the processing instructions to
acquire the related information according to a date and time relevant to the observation information.

5. The information processing apparatus according to claim 1, wherein the at least one processor is configured to execute the processing instructions to
generate the question sentence according to a date and time relevant to the observation information.

6. The information processing apparatus according to claim 1, wherein the at least one processor is configured to execute the processing instructions to
generate the question sentence requesting the answer for estimating a movement of the mobile body.

7. The information processing apparatus according to claim 1, wherein the at least one processor is configured to execute the processing instructions to
acquire text information including a sentence of a content related to the mobile body as the related information.

8. The information processing apparatus according to claim 1, wherein the at least one processor is configured to execute the processing instructions to
acquire satellite information obtained by observing a satellite that is the mobile body as the observation information.

9. An information processing method comprising
an information processing apparatus
acquiring observation information based on observation of a mobile body and acquiring related information related to the mobile body from information generated in advance,
generating a question sentence based on the observation information and the related information, and
inputting the question sentence to a model to obtain an answer to the question sentence from the model.

10. The information processing method according to claim 9, further comprising
generating and displaying the question sentence including at least a part of the observation information and the related information, and displaying the answer.

11. The information processing method according to claim 9, further comprising
acquiring the related information based on a content of the observation information.

12. The information processing method according to claim 11, further comprising
acquiring the related information according to a date and time relevant to the observation information.

13. The information processing method according to claim 9, further comprising
generating the question sentence according to a date and time relevant to the observation information.

14. The information processing method according to claim 9, further comprising
generating the question sentence requesting the answer for estimating a movement of the mobile body.

15. The information processing method according to claim 9, further comprising
acquiring text information including a sentence of a content related to the mobile body as the related information.

16. The information processing method according to claim 9, further comprising
acquiring satellite information obtained by observing a satellite that is the mobile body as the observation information.

17. A non-transitory computer-readable storage medium storing a program for causing an information processing apparatus to execute processing of:
acquiring observation information based on observation of a mobile body and acquiring related information related to the mobile body from information generated in advance;
generating a question sentence based on the observation information and the related information; and
inputting the question sentence to a model to obtain an answer to the question sentence from the model.
